(19) United States
(12) Patent Application Publication
(10) Pub. No.: US 2014/0052644 A1
(43) Pub. Date: Feb. 20, 2014

(54) SYSTEM, SOFTWARE AND METHOD FOR SERVICE MANAGEMENT

(71) Applicant: Dale R. OTT, Bradenton, FL (US)

(72) Inventor: Dale R. OTT, Bradenton, FL (US)

(73) Assignee: Vitil Solutions, Inc., Sarasota, FL (US)

(21) Appl. No.: 13/588,175

(22) Filed: Aug. 17, 2012

(51) Int. Cl. G06Q 10/00

(52) U.S. Cl. 705/304

(57) ABSTRACT

A system, software and a method are provided for management of service issues including knowledge articles, service designs, and performance metrics. Components are linked such that incremental real-time root cause analysis and problem solving may be provided. The system, software and method disclosed facilitate forensic analysis and techniques providing corrective re-design efforts to improve the service rather than short-term problem solving of reported service issues.

### FIELD

The present invention relates generally to the field of service management and more particularly to a system, software and a method that facilitate root cause analysis and resolution of service issues.

### BACKGROUND

A product or service provider generally attempts to address all foreseeable issues before the product or service is released; however, the provider cannot anticipate all possibilities. Unforeseeable issues often require a forensic process to understand the issue and to provide an initial solution (a “quick-fix” or work-around). The generally accepted practice to address a service issue is to simply record each request or complaint in the form of a “service ticket.” Multiple related and/or supporting service tasks (or work orders) may then be created to address the request, which tickets may capture information related to the issue and/or correction. This information may be later used for customer invoicing, rationalizing what work took place, comparison of individual work outputs, evaluation of commitment time requirements, etc.

However, treating each request as an isolated incident prevents real-time root cause analysis and may mask a defect in the design of the product or service. As a result, chronic issues may go undetected, and incomplete designs may continue to be unknowingly released into the stream of commerce.

Further, a service company may only document its services using a simplistic template or other imprecise definition of the services. As this methodology does not comprehensively capture the design attributes of each service, it leaves both the provider and the customer with an imprecise set of design attributes to describe the services. Accordingly, if an issue arises, customer support teams are limited in their ability to identify the root cause of a given failure due to the lack of detailed design attribute information. Rather, they can only address short-term solutions and hope to analyze data for information on a long-term or permanent fix at a later time.

Currently available service management systems, methods and software packages facilitate quick-fixes of service issues and do not facilitate real-time root cause analysis or methodology for recognizing, analyzing, and responding to failure trends. As such, there is a need for a service management system, method, and software that provide features for analyzing incoming failure data and provide linkage to the particular product/service design attribute(s) in need of change or correction to eliminate the failure(s) long-term.

### SUMMARY

According to an exemplary embodiment of the present invention there is provided a system, including: a server including memory and one or more processors; a knowledge article module having a search function, a new article function, and a usage function, wherein the knowledge article module is configured to store a plurality of knowledge articles, each of the plurality of knowledge articles including a compilation of readable text having a description of an issue with a service provided; a service design package module configured to store a plurality of design attributes of the service provided; a service ticket/task module configured to generate a compilation of at least one task directed to resolving the issue; and a dashboard module configured to display at least one of a knowledge article metric, a design package metric, and a ticket/task metric. The search function is configured to allow a user to search the plurality of knowledge articles for a user-defined search string and to allow the user to create and populate a new knowledge article. The usage function is configured to document a user selection of a knowledge article as relating to the issue. Each of the plurality of knowledge articles is configured to allow a user to link each of the plurality of knowledge articles with at least one of the plurality of design attributes. Each of the knowledge article module, the service design package module, the service ticket/task module, and the dashboard module are stored within the memory and executable by the one or more processors.

The usage function may be configured to be invoked by a user from within at least one of the plurality of knowledge articles. The usage function may automatically invoke the creation of a service ticket. The service ticket may include one or more tasks configured to address the issue described in the knowledge article.

The knowledge article metric may be selected from at least one of the number of times the usage function has been invoked for the knowledge article, the number of times the knowledge article has been edited, and the age of the knowledge article. A comment function may be configured to allow a user to add at least one of an alphanumeric comment and an attached document to each of the plurality of knowledge articles. The comment function may be stored within the memory and executable by the one or more processors.

The knowledge article module may be implemented as a document file system and each of the plurality of knowledge articles may be a separate document. The knowledge article module may be implemented as a database and each of the plurality of knowledge articles may be a database field.

The service design package module may be implemented as a service design database having a plurality of fields. The plurality of design attributes may be stored in the plurality of database fields and exactly one design attribute may be stored in exactly one database field.

The system may further include a network and a computing device. The system may be configured such that a user accesses the server via the computing device through the network.

According to an exemplary embodiment of the present invention there is provided software for service management, including computer readable instructions embedded on media and operable when executed to allow a user to: search a plurality of knowledge articles for an existing knowledge article addressing an issue with a service; if the existing knowledge article is not located: (i) create a new knowledge article and populate it with a description of the issue. (ii) link the new knowledge article to at least one design attribute of the service, (iii) link the new knowledge article to a ticket template, (iv) designate the new knowledge article as addressing the service request, (v) generate a service ticket comprising at least one task with a usage function within the new knowledge article, and (vi) manage the at least one task to completion; and if the existing knowledge article is located: (i) link the existing knowledge article to at least one design attribute of the service, (ii) update the existing knowledge article with a description of the issue, (iii) designate the existing knowledge article as addressing the service request, (iv) generate a service ticket request comprising at least one task with a usage function from within the existing knowledge article, and (v) manage the at least one task to completion. Each of the plurality of knowledge articles is a compilation of readable text comprising a description of the issue with the service. The at least one task is directed to resolving the issue.

The search may including the steps of: defining a search string of alphanumeric characters; inputting the search string into a search function, the search function configured to search the plurality of knowledge articles for the search string and to output any of the plurality of knowledge articles containing the search string; and reviewing the results of the search function and determining if any of the knowledge articles output by the search function address the issue. The string of alphanumeric characters may be selected such that it describes the issue.

Generation of the service ticket may be automatically performed upon invoking the usage function from within the one of the existing knowledge article and the new knowledge article. The service ticket may be dependent upon the issue described in the knowledge article. The service ticket may be further dependent upon the at least one design attribute linked within the knowledge article.

The software may be further configured to display at least one knowledge article metric. A knowledge article metric may be selected from at least one of: the number of times one of the plurality of knowledge articles has been designated as addressing an issue, the number of times one of the plurality of knowledge articles has been edited, and the age of one of the plurality of knowledge articles. The software may be further operable when executed to allow a user to: review the at least one knowledge article metric displayed; update one of the existing knowledge article and the new knowledge article with the current understanding of the issue described therein; or update at least one of a plurality of pre-defined service tickets. Each of the plurality of pre-defined service tickets may contain at least one task configured to resolve an issue described in one of the plurality of knowledge articles.

According to an exemplary embodiment of the present invention there is provided a method for service management, including: receiving a service request for an issue with a service having a plurality of design attributes; searching a plurality of knowledge articles for an existing knowledge article addressing the issue; if the existing knowledge article is not located: (i) creating a new knowledge article within the plurality of knowledge articles and populating it with a description of the issue, (ii) linking the new knowledge article to at least one design attribute of the service, (iii) linking the new knowledge article to a ticket template, (iv) designating the new knowledge article as addressing the service request; (v) generating a service ticket comprising at least one task with a usage function within the new knowledge article, and (vi) managing the at least one task to completion; and if the existing knowledge article is located; (i) linking the existing knowledge article to at least one design attribute of the service, (ii) updating the existing knowledge article with a description of the issue, (iii) designating the existing knowledge article as addressing the service request, (iv) generating a service ticket request comprising at least one task with a usage function from within the existing knowledge article, and (v) managing the at least one task to completion. Each of the plurality of knowledge articles is a compilation of readable text comprising a description of the issue with the service. The at least one task is directed to resolving the issue.

### BRIEF DESCRIPTION OF THE DRAWINGS

FIG. 1 is a diagram of a service management system according to an exemplary embodiment of the present invention.

FIG. 2 is a flowchart for implementing a service management method according to an exemplary embodiment of the present invention.

FIG. 3 depicts a screen shot of a knowledge article search function according to an exemplary embodiment of the present invention.

FIG. 4A depicts a top portion of a screen shot of a knowledge article according to an exemplary embodiment of the present invention.

FIG. 4B depicts a bottom portion of a screen shot of the knowledge article shown in FIG. 4A.

FIG. 5 depicts a screen shot of a portion of a knowledge article and associated editing function according to an exemplary embodiment of the present invention.

FIG. 5A depicts a screen shot of a portion of the knowledge article shown in FIG. 5.

FIG. 6 depicts a screen shot of a portion of a knowledge article and associated service design linking function according to an exemplary embodiment of the present invention.

FIG. 7 depicts a screen shot of a ticket template according to an exemplary embodiment of the present invention.

FIG. 8A depicts a screen shot of a portion of a dashboard function display according to an exemplary embodiment of the present invention.

FIG. 8B depicts a screen shot of a portion of the dashboard function display shown in FIG. 8A.

FIG. 8C depicts a screen shot of a portion of the dashboard function display shown in FIG. 8A.

FIG. 9 depicts a screen shot of a knowledge article creation template according to an exemplary embodiment of the present invention.

FIG. 10 depicts a screen shot of a compilation of knowledge article metrics according to an exemplary embodiment of the present invention.

### DETAILED DESCRIPTION

Like reference characters denote like parts in the drawings.

It is an object of the present invention to provide a system, software and an method for service management that provides the ability to provide incremental root cause analysis and problem solving. Certain embodiments relate problems back to the original service design attribute such that incremental improvements may be captured and implemented. It is a further object of this invention to provide a system, software and method for accumulating knowledge and for processing customer requests by recognizing dynamic, incrementally evolving, and forensic nature of service issues. The system, software and method provided may utilize said accumulated knowledge to reveal root causes of problems thereby transforming a support effort into a redesign-focused effort offering continuing improvement to product/service design, rather than addressing individual issues in a vacuum. It is therefore an object of the present invention to eliminate issues with a given product or service, rather than simply processing customer requests/failure reports efficiently.

A component of a system according to an exemplary embodiment of the present invention is a compilation of knowledge articles. Knowledge articles may be documents, files, or any other such construct known in the art capable of storing readable text and/or images. A compilation of knowledge articles may be implemented as one or more files stored on a hard drive, flash drive, computer disk, or any other such storage media. In other embodiments, a compilation of knowledge articles may be implemented as a database, wherein each database entry is a unique knowledge article.

Knowledge articles may be configured to store information on a given failure or any other such customer-stated issue or request, including, for example only: the short term workaround, specifics, and a root cause hypothesis. In some embodiments of the present invention, a knowledge article may include two or more categories and/or attributes, such as, for example only: whether the article was customer-initiated or information; usage (i.e., a counter, log, sequence of timestamps, or other such appropriate constructs configured to record the number of times the knowledge article is accessed or used); problem description; problem resolution description; root cause description; miscellaneous notes; routing information (i.e., identification of the person, department, or other such entity to which an issue is referred for resolution); one or more links or references to relevant attachments (i.e., other documents, files, or similar constructs containing information relating to the subject matter of the knowledge article); and one or more search tags (i.e., one or more terms identifying the subject matter of the knowledge article, wherein such tags are searchable via a search function implemented within the service management application).

In certain embodiments of the present invention, knowledge article content may be unalterable (i.e., “read-only”). In other embodiments users may add or edit information in the knowledge article as more information on the issue forming the subject matter of the knowledge article is gathered. In further embodiments, users may create new knowledge articles for newly discovered failures or customer reported issues. Such newly created knowledge articles may follow a pre-defined template, or may be as simple as a blank document to which the user adds a brief description of the new issue. Thus, in certain embodiments of the present invention, the process of creating and updating the content of a knowledge article may be crowd-sourced, that is, information may be added to the article incrementally by one or more users as more data is gathered about the subject failure or customer request. Such information may be added in the form of separate “comments,” or by directly editing the content of the article. When linked to at least one related design attribute of the product or service, such incremental updates allow for real-time problem and root cause analysis that can facilitate permanent or long-term changes to the design itself, rather than mere short-term “work-arounds.”

In certain embodiments of the present invention, the knowledge article may further include a function for creating a service ticket containing one or more tasks to resolve the issue described by the knowledge article. Also, a service management application may include a function for searching a compilation of knowledge articles. Combined, a user may utilize such a search function to locate a knowledge article addressing a given failure or customer request. If a relevant knowledge article is located, the user may then use that knowledge article's service ticket function to generate one or more tasks for resolving the failure or customer request. Once created, service tickets may be stored as documents in a file system, as fields in a service ticket database, or any other construct capable of storing readable text.

According to an exemplary embodiment of the present invention, the system, software application or associated method include a compilation of design attributes associated with a product or service, which may be defined as a service design package. Like knowledge articles, the service design package may be implemented as one or more documents, files, or other such constructs capable of storing readable text. In an exemplary embodiment, the service design package may be implemented as a database, wherein one or more design attributes of a given product or service is captured in the database field(s). Design attributes may include, but are not limited to: a unique identifier for the service design package; the name and/or description of the service; a service catalog; customer input such as customer requirements or stated beliefs; functional requirements such as legal or regulatory requirements to operate; quality control elements such as acceptance criteria or customer satisfaction actions; technical information such as technical catalog descriptions or known issues and associated workarounds; risk information such as risk categories, risk analysis, and non-compliance use impact and waiver thereof; links to reference materials such as sub services, other related technologies, industry documents, service provider documents, configuration descriptions; pricing information; Service Level Agreement (SLA) information, such as product/service defaults and exceptions thereto; relevant dates; and customer information such as structured flow charts, customer overviews, business catalog descriptions, training materials, procedures, and FAQ's. In certain embodiments of the present invention, the application may be configured to require the entry of one or more design attributes as “base content.” According to an embodiment of the present invention, users may enter information into a service design package by freely typing in design attributes or by selecting certain attributes from a pre-defined template. Finally, in some embodiments one or more design attributes may be further subdivided into one or more subcategories.

Facilitating incremental, “real-time” root cause analysis (rather than triaging a failure or customer request and dealing with root cause analysis at a later time), the present invention may be configured such that users may link knowledge articles with one or more design attributes of the product or service supported by the users. Thus, according to an exemplary embodiment of the present invention, the knowledge article may further include a linking function whereby a user may link said knowledge article (and thus the issue described therein) to one or more design attributes captured in the service design package.

In certain embodiments, the knowledge article may be dynamically linked to a design attribute within a structured service design package database. In some embodiments, this functionality may be implemented as one or more dropdowns or “picklists” incorporated into the knowledge article, wherein the selections in the dropdown/picklist may be linked to a service design package such that a user may navigate the list of design attributes and select a related supporting service, configuration document, or other component. This “reach through” functionality enables the user to link the knowledge article with the specific product/service design attribute, thereby enabling drill down reporting and problem analysis. In such embodiments, knowledge article linkage may affect, limit, or otherwise define the one or more tasks created by the service ticket function of the knowledge article. Accordingly, as the information in a given knowledge article is incrementally advanced/supplemented, users of the application may view not only information on the failure/issue as it evolves, but also information on the related design attribute(s) wherein the root cause for the failure/issue lies. As ticket/tasks are associated with a specific knowledge article, the knowledge article adjustments establish an increasingly more accurate relationship to the specific design attribute associated with the root cause. When combined with a metrics or “dashboard” display, users may thus have access to “real-time” information relating to trending issues with the design itself, thereby facilitating quick and efficient root cause analysis and enabling insights for immediate and long-term solutions.

In order to better view and process information within the service management application as it comes in, exemplary embodiments of the present invention may further include various dashboards. Dashboards may be configured to display one or more metrics detailing information about one or more issues tracked by the service management application such that a user more easily identify trends. For example, a metric illustrating the knowledge article “used” (i.e., a service ticket created) and organized in descending order (i.e., the most “used” knowledge article on the top of the list) prioritizes the knowledge articles in need of review so that an engineer or engineering team can investigate and add further instructions/insight to the knowledge article, and further refine the associated service ticket. Metrics may be pre-set or custom defined by a user. Metrics may include, but are not limited to: new knowledge articles created; knowledge article most recently updated/commented upon; and knowledge articles most recently “used” (i.e., a service ticket created). Metrics may be calculated over a pre-defined or user-defined period of time.

In certain embodiments of the present invention, the service management systemt may be implemented as a software application residing on a single computing device. In other embodiments, the software application may be on a server or other such computing device accessible over a network, wherein one or more users access the software application remotely across the network via one or more network-capable computing devices. In still other embodiments, a portion of the software application may be installed on one or more remote computing devices, which are configured to remotely access across a network, the remainder of the software application running on a server or other such network-capable device.

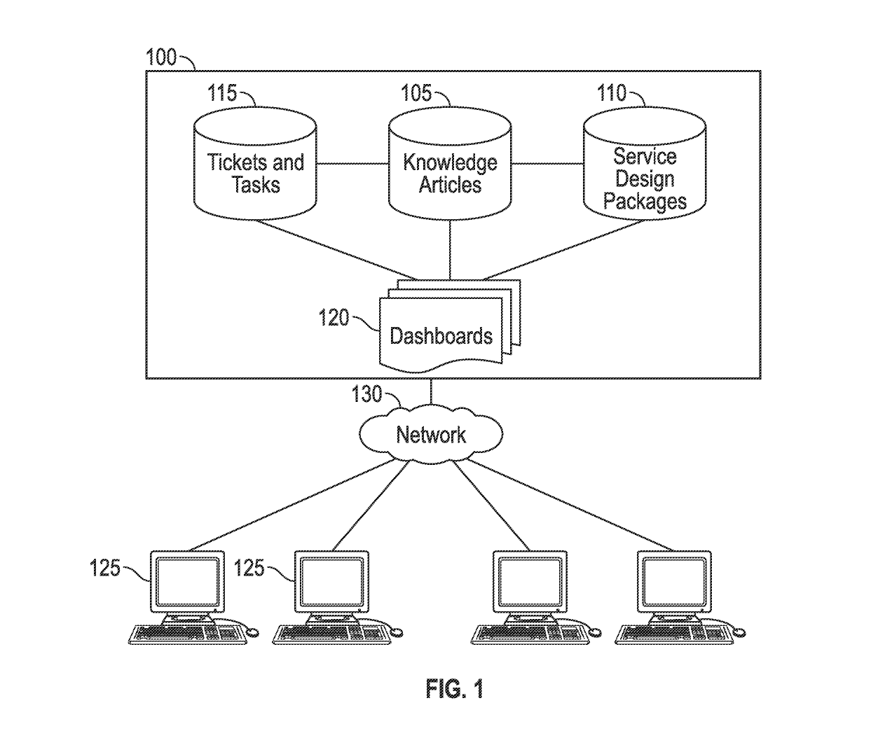

FIG. 1 illustrates components of a service management system 100, according to an exemplary embodiment of the present invention. System 100, which may be implemented as a software application, may include a knowledge article module 105, a service design package module 110, a tickets and tasks module 115, and dashboards 120. In certain embodiments, system 100 may reside as a software application on a single computer, hard drive, mobile device, or other such computing device. In other embodiments, one or more components of system 100 may reside as a software application on a server or other such network-capable device, and one or more computing devices 125 may access application 100 across a network 130.

Knowledge article module 105 may be configured to store one or more knowledge articles, which may be documents, files, or any other such construct known in the art capable of storing readable text and/or images. Module 105 may be implemented as one or more files stored on a hard drive, flash drive, computer disk, or any other such storage media. In other embodiments, a compilation of knowledge articles may be implemented as a database, wherein each database entry is a unique knowledge article. According to an exemplary embodiment of the present invention, each knowledge article may further include a function for creating a service ticket via invoking tickets and task module 115, wherein a ticket may include one or more tasks configured to eliminate or mitigate the failure or issue forming the subject of the knowledge article. In further embodiments, each knowledge article may further include a linking function, wherein said function is configured to allow a user to link a knowledge article with one or more design attributes stored in service design package module 110.

Service design module 110 may be configured to store one or more design attributes for one or more products or services. Service design module may be implemented as one or more files stored on a hard drive, flash drive, computer disk, or any other such storage media. In an exemplary embodiment, service design module 110 is implemented as a database, wherein one or more design attributes is stored in the field(s) of the database. In some embodiments, a design attribute may be a single attribute, or it may be a list, compilation, or sub-database of attributes associated with a given attribute. In further embodiments, service design module 110 may be implemented as a series of databases.

Tickets and tasks module 115 may be a function configured to generate a service ticket featuring at least one task, wherein the at least one task is tailored to eliminate the issue associated with a given knowledge article. In an exemplary embodiment of the present invention, a user may locate a knowledge article within knowledge article module 105. If said knowledge article addresses the failure/issue being researched by the user, the user may then invoke tickets and tasks module 115 from within the knowledge article. System 100 may be configured to automatically populate at least one task into a given ticket based upon the information contained in the knowledge article, including linkage to service design package 110.

Dashboards 120 may be configured to display one or more metrics detailing information about one or more issues tracked by the service management application such that a user may more easily identify trends and areas of the design of the product/service needing improvement. Metrics may include, but are not limited to: new knowledge articles created; knowledge article most recently updated/commented upon; and knowledge articles most recently “used” (i.e., a service ticket created). Dashboards 120 may also be configured to display statistics relating to individual user performance. Metrics may be calculated over a pre-defined or user-defined period of time.

System 100 may further incorporate other features, including but not limited to: one or more user interface modules for entering and/or displaying information knowledge article module 105, service design package 110, tickets and tasks module 115, dashboards 120, or any other system functions or components. Said user interface may be implemented as a part of system 100, or as a separate application that accesses the information, modules, and other features of system 100 either from the same computing device or remotely across network 130. In an exemplary embodiment of the present invention, system 100 further includes a search function whereby a user may search the knowledge articles of knowledge article module 105 for a word, phrase, or other such string of alpha-numeric characters. Said search function may be further configured to allow searching of the information within service design package 110, tickets and tasks module 115, or any other components of system 100.

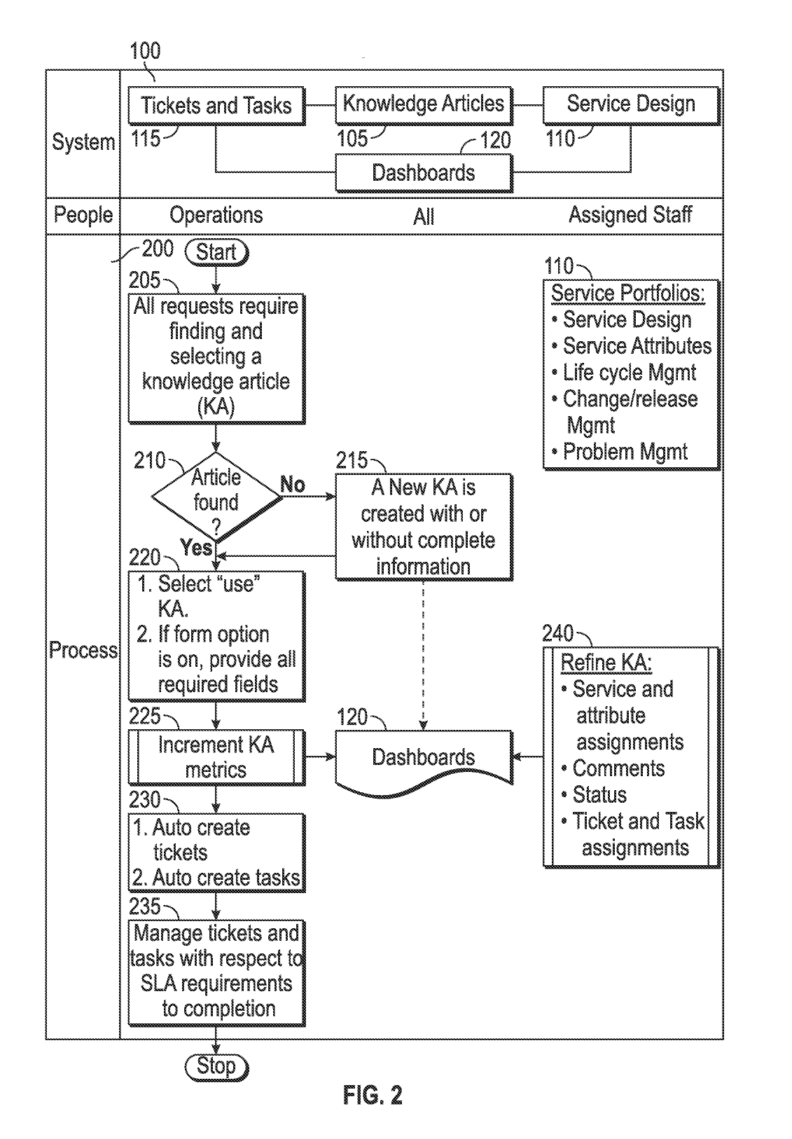

FIG. 2 is a flowchart for implementing a service management method 200 according to an exemplary embodiment of the present invention. Method 200 may include the following steps:

205: Upon receipt of a customer request or other such notice of a product/service failure, a customer service representative or other such user of the system 100 may first search for a knowledge article relating to the request/failure at issue. In certain embodiments, this may be accomplished by a search function incorporated into system 100, wherein the user searches for a word, phrase, or other such description of the request/failure.

210: The user determines whether the search has revealed a knowledge article that relates to the request/failure at issue.

215: If no knowledge article yet exists, the user may create a new knowledge article, wherein the user records a description of the request/failure. In certain embodiments, a function for creating a new knowledge article may be incorporated into knowledge article module 105, or at some other portion of system 100.

220: Once within the knowledge article relating to the request/failure (whether pre-existing or newly created) a user may “use” or otherwise designate the applicability of the knowledge article to the current failure/issue. In some embodiments of the present invention, a “use” function may be linked to or incorporated into a knowledge article, wherein said function logs or otherwise records that the article has be used to address a request/failure, and may further initiate a service ticket within tickets and tasks module 115. The user may also update the knowledge article by adding additional information relating to the request/failure and/or any solution(s) thereto. The user may also link the knowledge article to one or more design attributes contained in service design package 110. In certain embodiments, such linkage may be established via a linking function, wherein the user selects one or more design attributes from one or more dropdown boxes/picklists linked to service design package 110.

225: The knowledge article metrics (i.e., usage count, time/date of usage, user information, etc.) may then be updated. In certain embodiments of the present invention, the updated metrics are viewable via the one or more dashboards 120.

230: Once a knowledge article is selected, one or more service tickets may be generated, wherein the one or more service tickets contain one or more tasks directed at solving, eliminating, or otherwise addressing the request/failure. In an exemplary embodiment of the present invention, said ticket(s) is automatically generated by system 100 or by tickets and tasks module 115 therein.

235: One or more users may then manage the tickets/tasks, subject to any Service Level Agreement existing with the customer.

240: At or after the time the knowledge article metrics are updated (225) and available for viewing by dashboard 120, a user of system 100 may update the relevant knowledge article. Such updates may include, but are not limited to: description of the failure/issue; updating the dynamic linking of the knowledge article to one or more design attributes of service design package 110; adding additional comments; updating the status of the failure/issue; and updating the ticket and/or tasks automatically generated by tickets and tasks module 115 when said knowledge article is “used.” Because knowledge articles are incrementally updated, a user may attain a “real time” problem/root cause analysis from the metrics. For example, the metrics and associated dashboard displays may be configured to present a user with information relating to trending (i.e., more heavily used) knowledge articles and associated design attribute(s), thereby indicating a chronic issue with one or more elements of the overall design. Such information may thus facilitate a long term solution involving a change or other improvement to the design, thereby eliminating the trending issue.

### EXAMPLE

### Password Reset Request

What follows is an example of the usage of a service management software application according to an exemplary embodiment of the present invention. This example is not intended to encompass all features or components of the service management software application or the associated system and method as described by the present invention, but is included for illustrative purposes. This example considers a scenario wherein a customer has requested assistance in resetting their password.

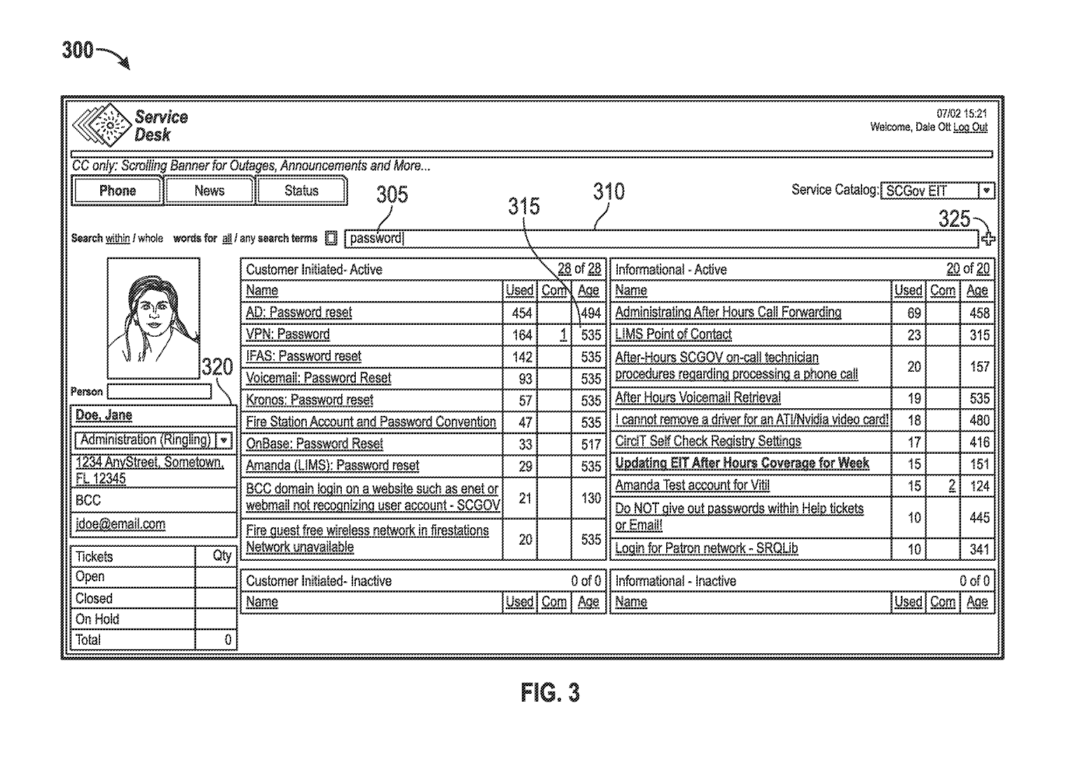

FIG. 3 depicts a screen shot 300 of a knowledge article search function according to an exemplary embodiment of the present invention. Upon receipt of a customer request (e.g., assistance in changing name/email within the product/service supported), a user may enter a search term 305 into search box 310. The search function within the application may then search all or a sub-group of knowledge articles for term 305 and display the search results 315. If one of the knowledge articles within results 315 addresses the customer request, the user may select that knowledge article by clicking its name. In this example, the user has entered search term 305 as “password,” and ten knowledge articles relating to term 305 were displayed in search results 315. If no appropriate knowledge article is found, the user may initiate the creation of a new knowledge article by clicking new article button 325.

In certain embodiments of the present invention, the software application may require the user to identify himself/herself prior to usage of the application. Such functionality may be implemented as a user login/password structure, by selecting a name from a dropdown box or picklist, or by any other such appropriate means known in the art. Thereafter, user information 320 may be displayed on one or more screens within the software application. The software application may further include filters which allow access only to knowledge articles associated with that user or that user's organization. The software application may also limit service catalogs available to that user.

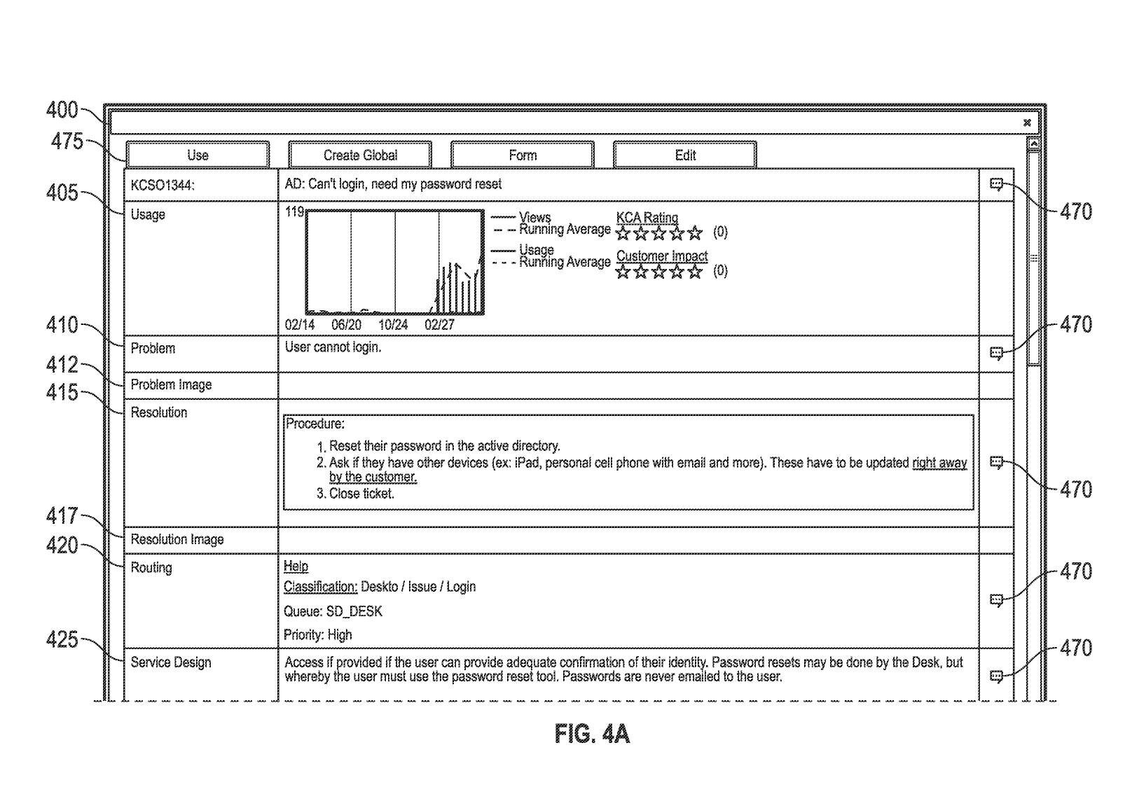

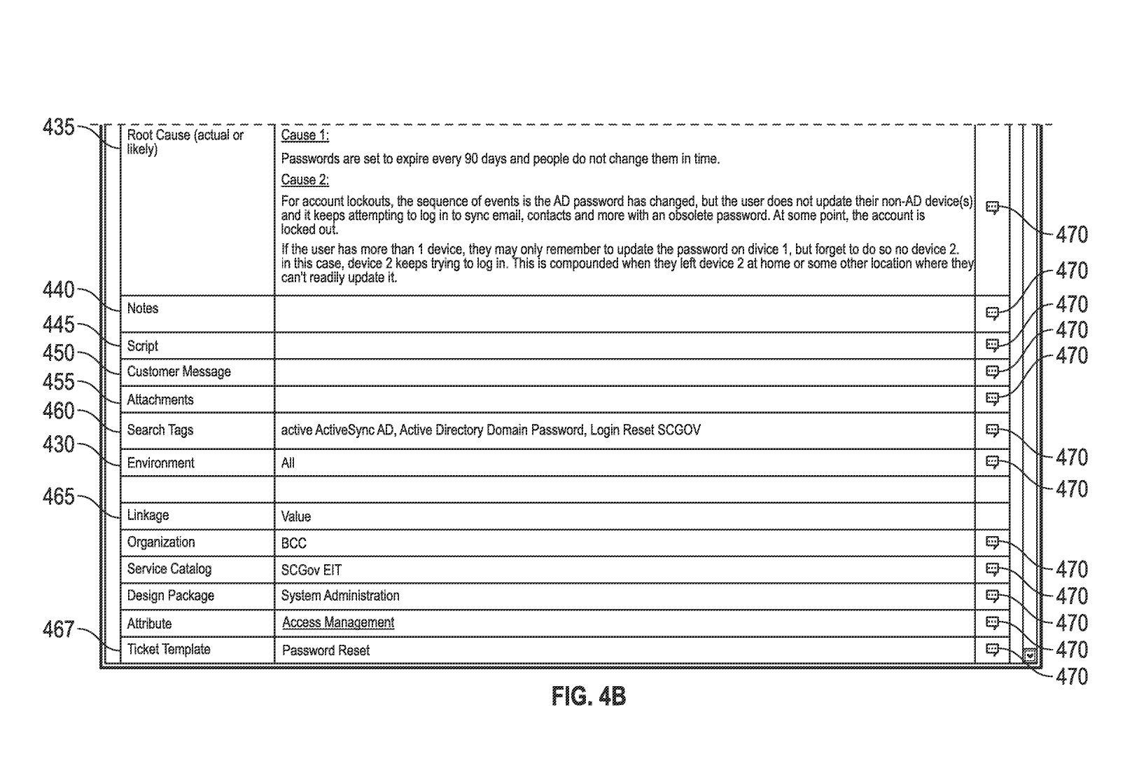

FIGS. 4A and 4B depict screen shots of a knowledge article 400 according to an exemplary embodiment of the present invention. In certain embodiments of the present invention, knowledge article 400 may be subdivided into a plurality of sections. Usage section 405 may display the usage history of knowledge article 400, either in graphical or text format. Usage section 405 may further include one or more ratings for knowledge article 400. Problem section 410 may include a description of the failure/request addressed by knowledge article 400. In this example, the user has selected the knowledge article 400 addressing the request, “AD: Can't login, need password reset.” Resolution section 415 may include the description of one or more solutions to the problem 410 forming the subject matter of knowledge article 400. Routing sections 420 may identify one or more users, teams, or other entities to whom resolution of Problem 410 will be assigned. Service design section 425 may include information on the service design package and/or one or more associated design attributes selected in Linking section 465. Environment section 430 may include a description of the environment within the supported product/service where knowledge article 400 is applicable. Root Cause section 435 may include a description of the root cause of Problem 410. Notes section 440 may include miscellaneous notes entered by one or more users. Script section 445 may identify any scripts available within the service relating to problem 410. Customer Message section 450 may include a message for the customer relating to Problem 410. Attachment section 455 may identify any supporting documents attached/linked to knowledge article 400. Search Tags 460 may include one or more words or phrases searchable by a search function within the application. Such a function may search for search term 305 within the full text of a group of knowledge articles, or within the search tags sections of those knowledge articles Linking section 465 may include linkage to one or more design attributes within a service design package relating to Problem 410. Ticket template 467, which may be within linking section 465, may include linkage to a specific set of tasks pre-sequenced with the most current known method of addressing the issue.

In some embodiments of the present invention, a user may add comments to one or more sections of knowledge article 400. Comments may be added by clicking the comment button 470 associated with the section to receive the comment. Finally, knowledge article 400 may include use button 475, which may serve several functions, including but not limited to: designating the usage of knowledge article 400 to address a customer request (thereby updating the usage statistics/metrics in Usage section 405), and initiating the creation of one or more service tasks, which are pre-sequenced with the most current method of addressing the issue.

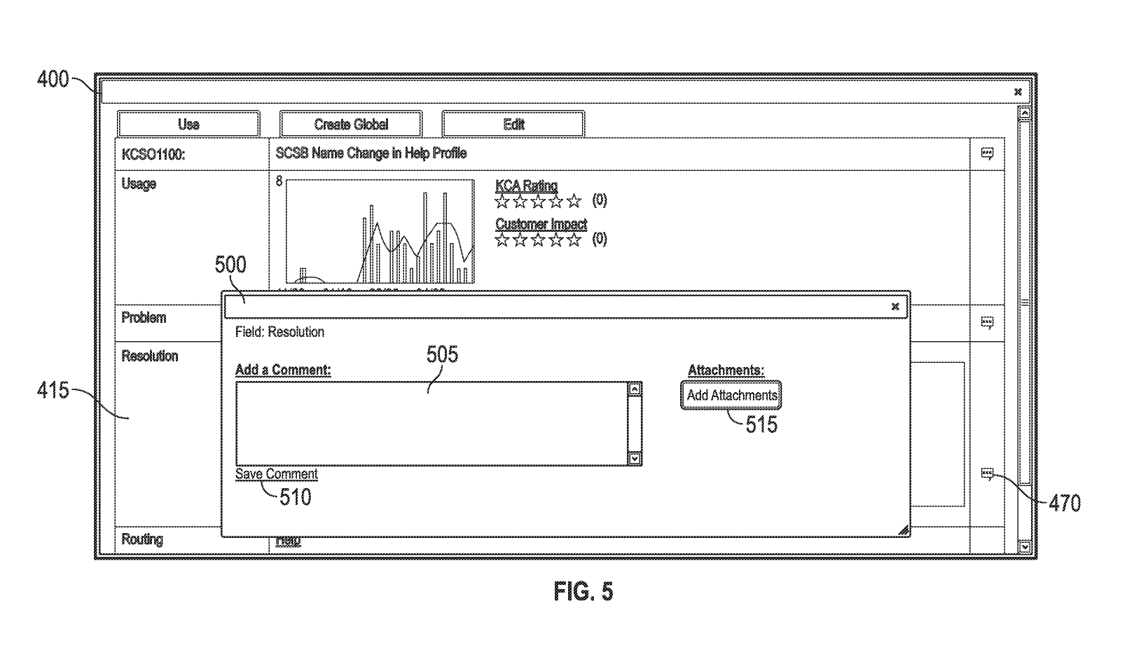

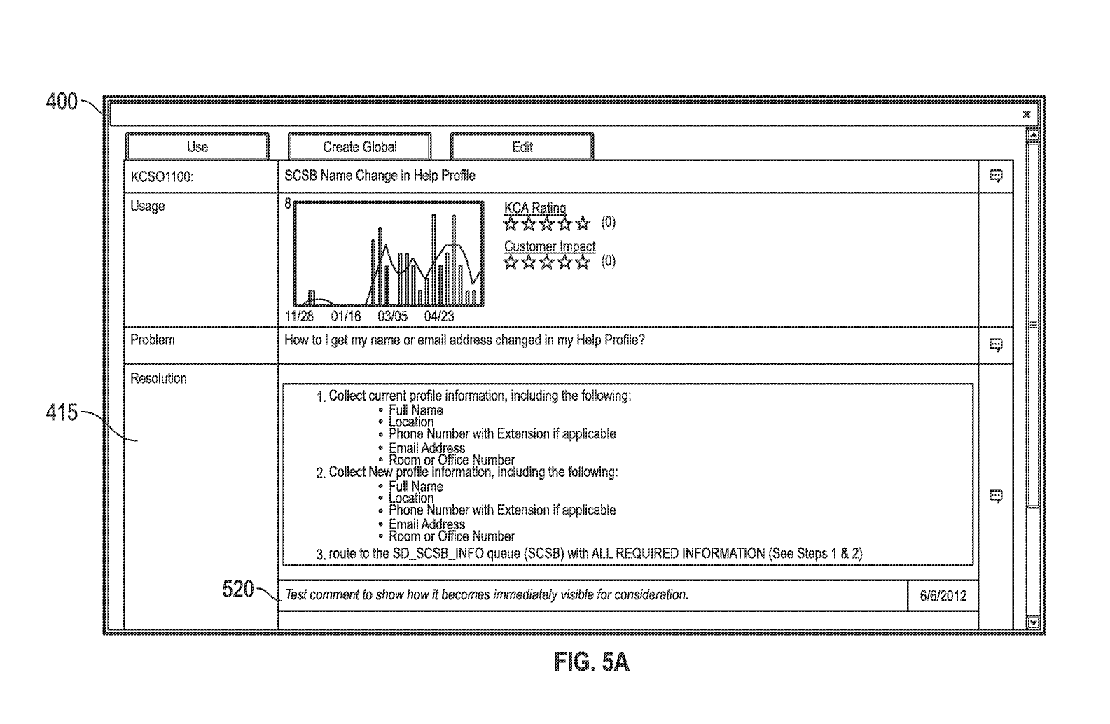

FIGS. 5 and 5a depict screen shots of a portion of a knowledge article 400 and associated commenting function 500 according to an exemplary embodiment of the present invention. When a comment button 470 is clicked, the commenting function 500 is initiated. Comment function 500 may include text box 505 within which the user may enter text 520 to be added to knowledge article 400, which text is added upon clicking Save button 510. Comment function 500 may further include Attachment button 515, which initiates a function for attaching/linking one or more documents to knowledge article 400. Finally, comment function 500 may identify the section of knowledge article 400 being commented upon. In this example, the user is adding a comment to Resolution section 415 of knowledge article 400. As demonstrated in FIG. 5a, text 520 appears below the appropriate section of knowledge article 400. In this example, the user has added comment text 520 to Resolution section 415. In some embodiments, the author name may be omitted to avoid reader bias.

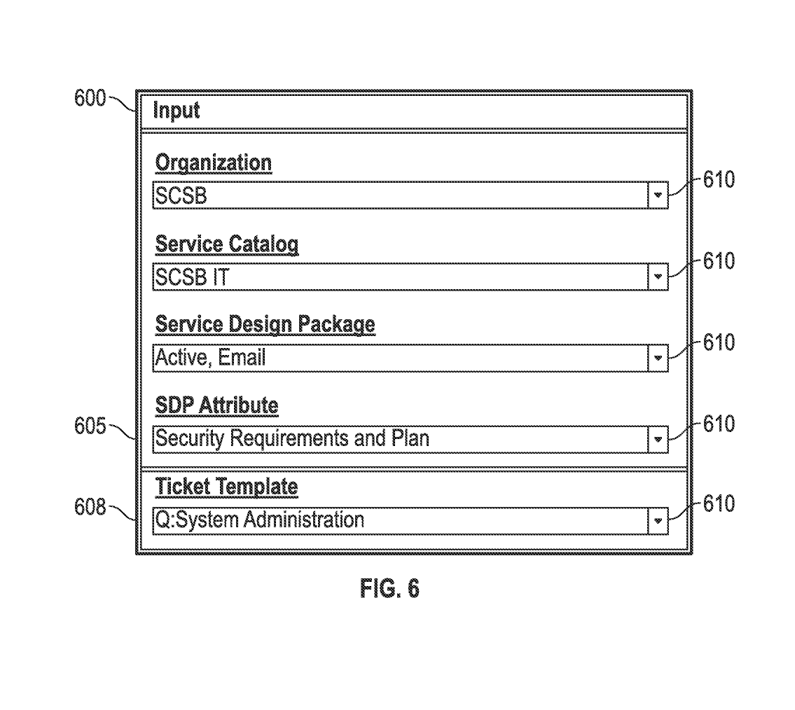

FIG. 6 depicts a screen shot of a portion of knowledge article 400 and associated service design package linking function 600, according to an exemplary embodiment of the present invention. As discussed elsewhere in this application, knowledge article 400 may be dynamically linked to a structured service design package, which may be implemented as a database containing one or more design attributes of the product/service supported according to an exemplary embodiment of the present invention Linking function 600 allows a user to link knowledge article 400 to one or more design attributes 605. Linking function 600 may contain one or more dropdown boxes/picklists 610 that allow the user to not only select the appropriate attribute(s) 605, but also identify the user's organization, the appropriate service catalog, and a ticket template. In some embodiments, a pre-defined ticket template containing one or more tasks may be available for a given knowledge article 400 when linked with a particular design attribute 605. In this example, the user has selected the “System Administration” service design package and identified the relevant design attribute to be the “Access Management” (indicating that the customer request is related to this specific design attribute which provides the baseline context in which the issue should be analyzed). After entry, the options selected in linking function 600 may be displayed within knowledge article 400 in Linking section 465 and the specific design attribute displayed in section 425. In some embodiments, linking function 600 may be displayed in the Linking section 465 (by using the associated dropdown box/picklist 610). To create the prescribed tickets and tasks to solve this issue, 608 contains a ticket template which is created in section 700. Linking function 600, combined with dashboard function display 800, may facilitate intuitive and efficient problem/root-cause analysis, as a user may obtain “real time” information relating knowledge article usage with associated design attributes as the one or more knowledge articles are incrementally updated.

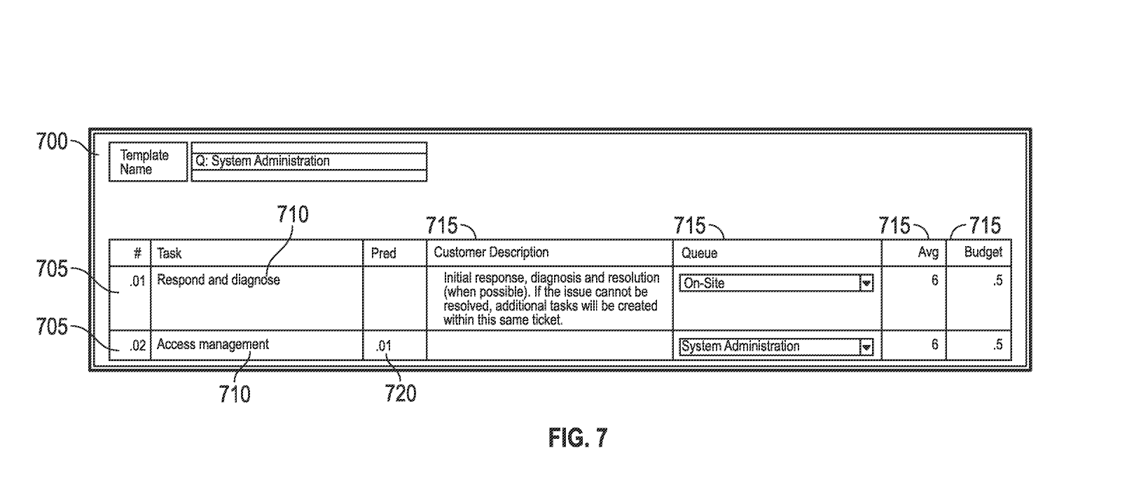

FIG. 7 depicts a screen shot of a ticket template 700 according to an exemplary embodiment of the present invention. Ticket template 700 may contain a sequence of one or more tasks 705 directed to the resolution of Problem 410. In addition to task descriptions 710, template 700 may further include other information 715 specific to each task 705, such as identification of preceding tasks, appropriate queue(s), expected time to task completion, and estimated task budget. In certain embodiments of the present invention, the ticket template 700 is associated with the knowledge article 700 identified. In this example, the ticket template includes two tasks 705 for resolving the customer request: respond and diagnose and access management. Further, task 2 requires task 1 to be completed first. This predecessor option can be set as needed for a plurality of tasks.

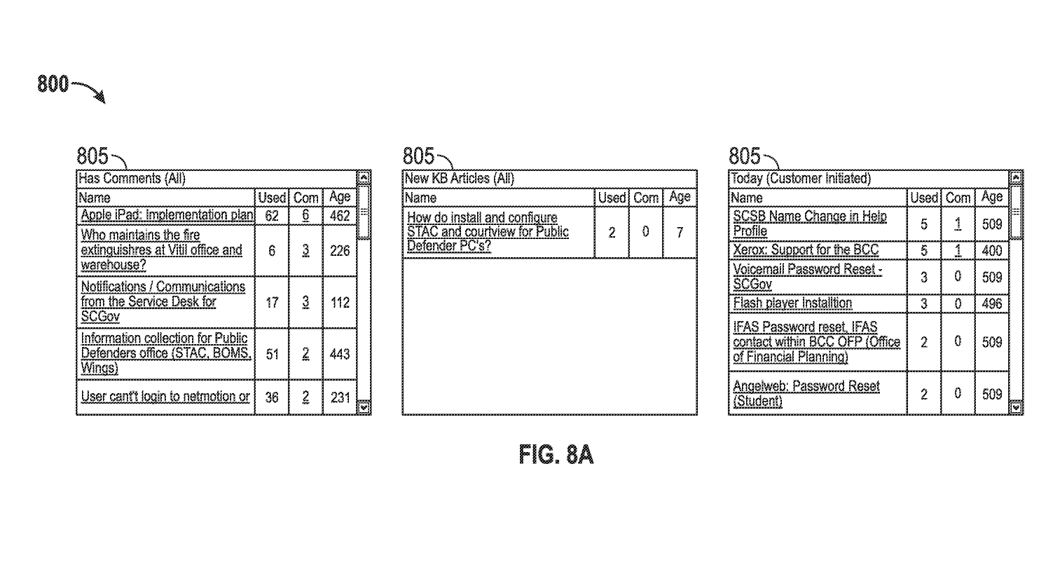

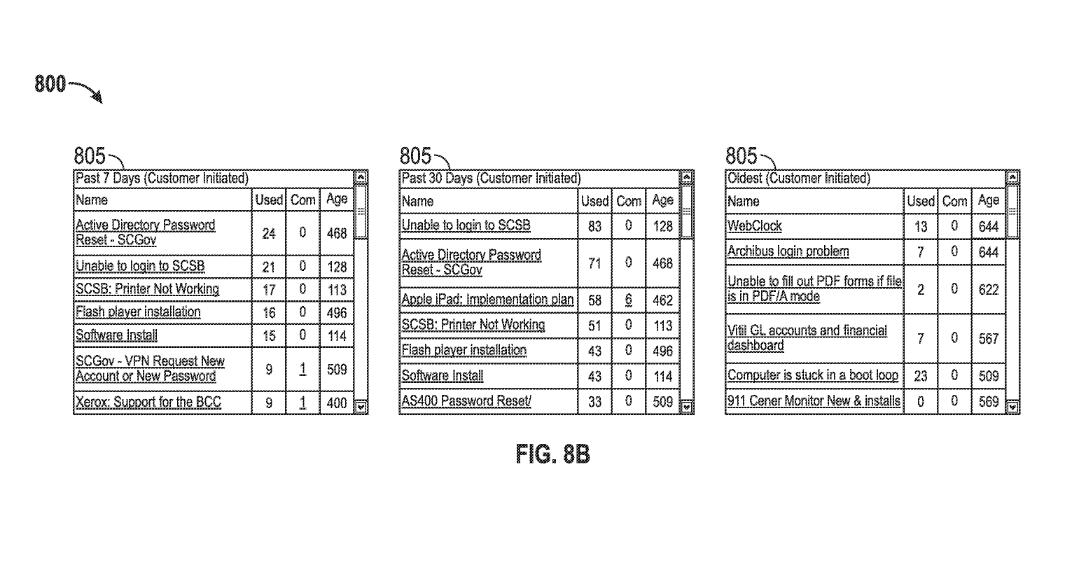

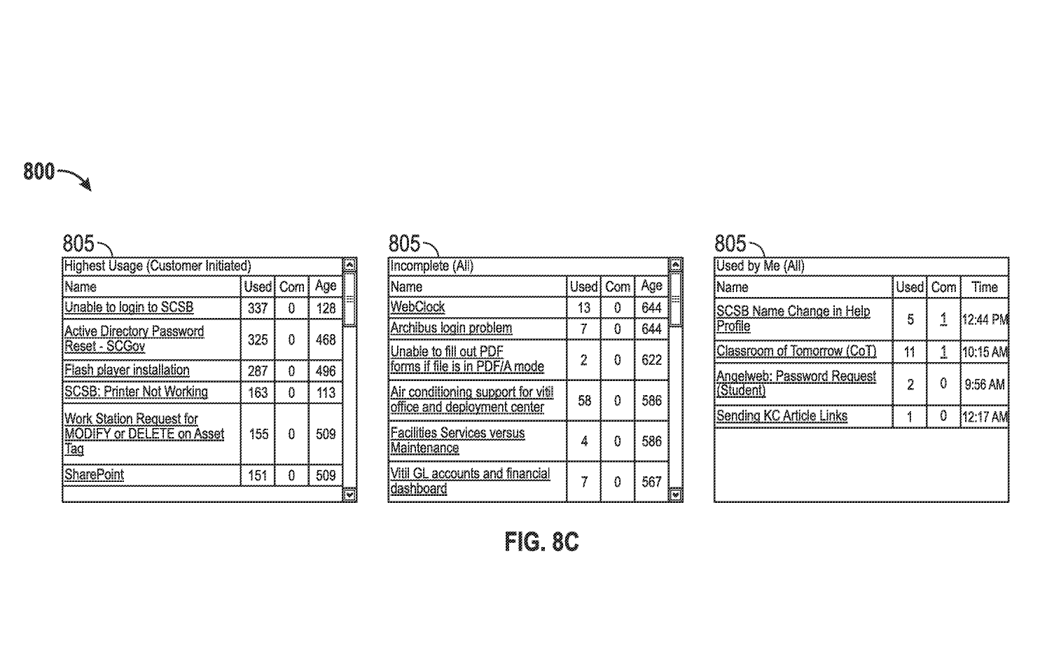

The software application may further include a dashboard function configured to display certain metrics and statistics regarding knowledge articles, designs and tickets/tasks managed therein. FIGS. 8A to 8C depict screen shots of dashboard function display 800 according to an exemplary embodiment of the present invention. Dashboard function 800 may include one or more components 805, each of which displays information regarding knowledge article metrics. In this example, dashboard function display 800 includes nine components 805 displaying (left to right from the upper left and then down): knowledge articles commented upon, new knowledge articles created (all), new knowledge articles used today (current day), knowledge articles used in the past 7 days, knowledge articles used in the past 30 days, oldest knowledge articles, highest usage knowledge articles, incomplete knowledge articles and knowledge articles used by me. Within each dashboard, for each knowledge article listed, also displayed are the article's number of usages, number of active comments, and age (days). A user viewing these dashboards may gain valuable insights into the most pressing needs of the supporting system and associated design, as data regarding knowledge articles may be displayed in “real time” as they are incrementally updated. In this example, the most used knowledge article overall and in the past 30 days is “Unable to Log Into SCSB,” thereby indicating that the design attributes associated with this issue should be investigated.

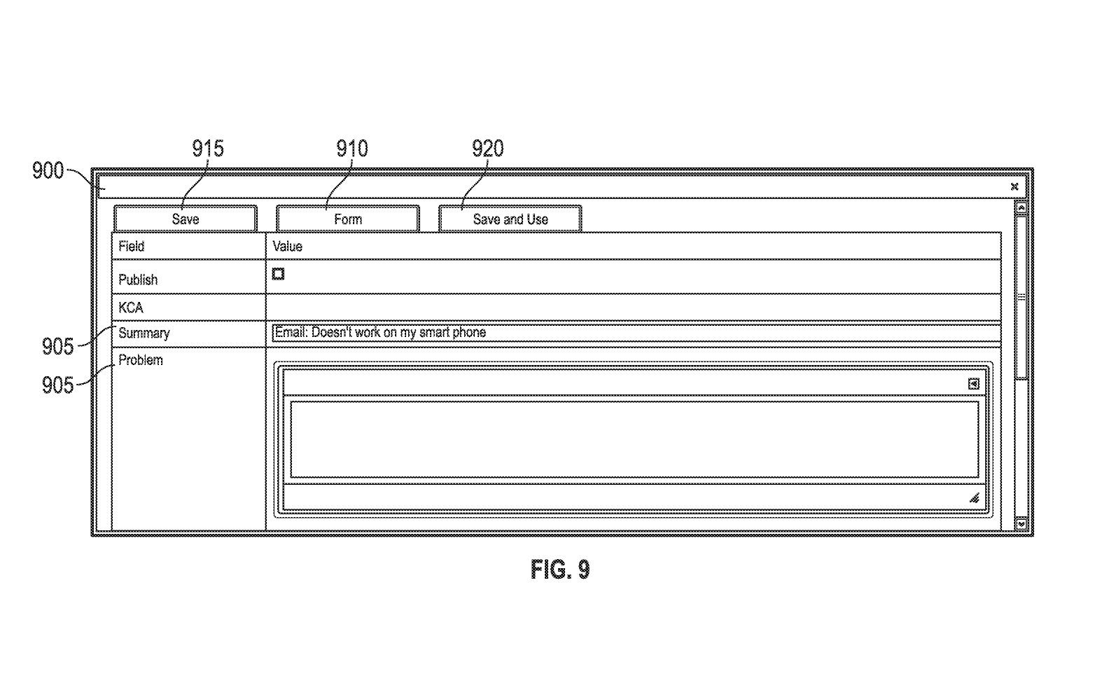

If no appropriate knowledge article had be located within search results 315 for search term 305, the user had the option to create a new knowledge article using new article button 325. FIG. 9 depicts a screen shot demonstrating a knowledge article creation template 900 according to an exemplary embodiment of the present invention. Template 900 may contain one or more fields 905 into which a user may record information relating to the request/issue. In certain embodiments, the user has the option of selecting from one or more pre-defined knowledge article forms, which in this example are accessed by using Form button 910. Upon completion of the new knowledge article the user may use save button 915 to save the knowledge article, or save and use button 920 to both save the knowledge article and designate its usage for the pending request/issue. The user may enter any such appropriate description of the pending request/issue into the one or more fields 905 as the issue is currently understood. Even with a phrase or sentence fragment, the knowledge article may be saved and used.

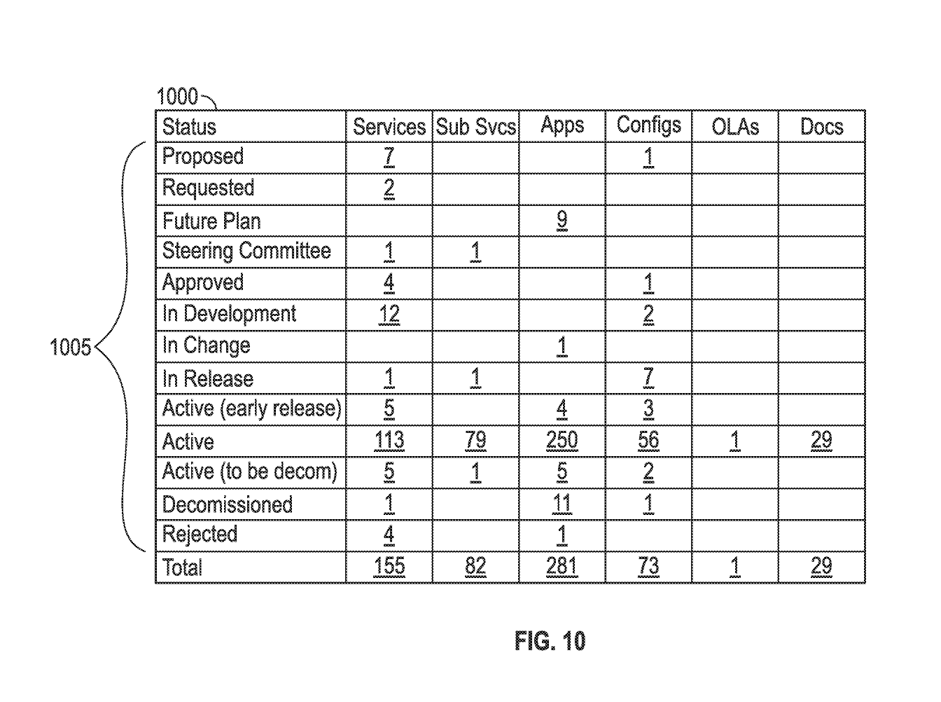

Embodiments of the present invention need not be devoted to only one service or design. For example, when linking a knowledge article 400 with a design attribute 605, a user may first select from a number of service design packages, each of which comprises the design attributes of a separate supported service. In some embodiments, a user may select from one or more service design packages via one of dropdown boxes 610. Accordingly, certain embodiments of the present invention may further include one or more metric displays for tracking the development of multiple services, including, but not limited to, the current status of those services as they progress through a development lifecycle. FIG. 10 depicts a screen shot demonstrating a metric display 1000 configured to display the status of services progressing through a plurality of lifecycle stages 1005. Such stages 1005 may include, but are not limited to, Proposed; Requested; Future Plan; Steering Committee; Approved; In Development; In Change; In Release; Active (early release); Active; Active (to be decommissioned); Decommissioned; and Rejected.

According to certain embodiments of the present invention, the system for service management may be implemented as a software program, said software program comprising computer readable instructions stored on media. In further embodiments, said software may be stored on a system comprising a server including memory and at least one processor. Such a system may further comprise a network and at least one remote computing device configured such that a user may access the server, and thus the software application stored therein, across the network. In other embodiments the software program may be stored on one or more computing devices.

A server may include memory and one or more processors and comprises an electronic computing device operable to receive, transmit, process, store or manage data associated with the system. Generally, this disclosure provides merely one example of computers that may be used with the disclosure. As used in this document, the term “computer” is intended to encompass any suitable processing device. For example, the platform can be implemented using computers other than servers, as well as a server pool. Indeed, the server may be any computer or processing device such as, for example, a blade server, general purpose personal computer (PC), Macintosh, workstation, Unix-based computer, or any other suitable device. In other words, the present disclosure contemplates computers other than general purpose computers as well as computers without conventional operating systems. The server may be adapted to execute any operating platform including Linux, UNIX, Windows Server, or any other suitable operating system. According to one embodiment, the server may also include or be communicably coupled with a web server and/or a mail server.

The server also includes a processor. The processor executes instructions and manipulates data to perform the operations of the server such as, for example, a central processing unit (CPU), a blade, an application specific integrated circuit (ASIC), or a field [symbol] programmable gate array (FPGA). Although described as a single processor in the server, multiple processors may be used according to particular needs and reference to processor is meant to include multiple processors where applicable. In certain embodiments, the processor executes the application for service management as described herein. Regardless of the particular implementation, “software” may include software, firmware, wired or programmed hardware, or any combination thereof as appropriate. Indeed, the application for service management may be written or described in any appropriate computer language including C, C++, Java, Visual Basic, assembler, Perl, any suitable version of 4GL, as well as others. Further, while described as internal to the server, one or more processes associated with an application for service management may be stored, referenced, or executed remotely. For example, a portion of the application may be a database stored at a remote computing device, accessible across the network. Moreover, the application for service management may be a child or sub-module of another software module or enterprise application without departing from the scope of this disclosure.

Memory may include any memory or database module and may take the form of volatile or non-volatile memory including, without limitation, magnetic media, optical media, random access memory (RAM), read-only memory (ROM), removable media, or any other suitable local or remote memory component. For example, the memory may store classes, frameworks, applications, backup data, jobs, or other information that includes any parameters, variables, algorithms, instructions, rules, or references thereto. The memory may also include any other appropriate data such as VPN applications, firmware logs and policies, firewall policies, a security or access log, print or other reporting files, HTML files or templates, and others.

The network facilitates wireless or wireline communication between the server and any other local or remote computing device. The network may be all or a portion of an enterprise or secured network. In another example, the network may be a virtual private network (VPN) merely between the server and a client remote computing device across wireline or wireless link. Such an example wireless link may be via 802.11a, 802.11b, 802.11g, 802.11n, 802.20, WiMax, and many others. While described as a single or continuous network, the network may be logically divided into various sub-nets or virtual networks without departing from the scope of this disclosure, so long as at least portion of the network may facilitate communications between the server and at least one client. In other words, the network encompasses any internal or external network, networks, sub-network, or combination thereof operable to facilitate communications between various computing components in the system. The network may communicate, for example, Internet Protocol (IP) packets, Frame Relay frames, Asynchronous Transfer Mode (ATM) cells, voice, video, data, and other suitable information between network addresses. The network may include one or more local area networks (LANs), metropolitan area networks (MANs), wide area networks (WANs), all or a portion of the global computer network known as the Internet, and/or any other communication platform or systems at one or more locations. In certain embodiments the network may be a secure network associated with the enterprise and certain local or remote computing devices.

While the embodiments are described with reference to various implementations and exploitations, it will be understood that these embodiments are illustrative and that the scope of the invention(s) is not limited to them. In general, embodiments of an application and method for service management as described herein may be implemented using methods, facilities, and devices consistent with any appropriate hardware or software systems, or a combination thereof. Many variations, modifications, additions, and improvements are possible.

For example, plural instances may be provided for components, operations or structures described herein as a single instance. Boundaries between various components, operations and functionality are depicted somewhat arbitrarily, and particular operations are illustrated within the context of specific illustrative configurations. Other allocations of functionality will also fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A system, comprising:
a server including memory and one or more processors;
a knowledge article module having a search function, a new article function, and a usage function, wherein the knowledge article module is configured to store a plurality of knowledge articles, each of the plurality of knowledge articles including a compilation of readable text having a description of an issue with a service provided;
a service design package module configured to store a plurality of design attributes of the service provided;
a service ticket/task module configured to generate a compilation of at least one task directed to resolving the issue; and
a dashboard module configured to display at least one of a knowledge article metric, a design package metric, and a ticket/task metric;
wherein the search function is configured to allow a user to search the plurality of knowledge articles for a user-defined search string and to allow the user to create and populate a new knowledge article;
wherein the usage function is configured to document the user's selection of a knowledge article as relating to the issue;
wherein each of the plurality of knowledge articles is configured to allow the user to link each of the plurality of knowledge articles with at least one of the plurality of design attributes; and
wherein each of the knowledge article module, the service design package module, the service ticket/task module, and the dashboard module are stored within the memory and executable by the one or more processors.

2. The system of claim 1, wherein the usage function is invoked by the user from within at least one of the plurality of knowledge articles.

3. The system of claim 2, wherein the usage function automatically invokes the creation of a service ticket, the service ticket comprising one or more tasks configured to address the issue described in the knowledge article.

4. The system of claim 1, wherein the knowledge article metric is selected from at least one of the number of times the usage function has been invoked for the knowledge article, the number of times the knowledge article has been edited, and the age of the knowledge article.

5. The system of claim 1, further comprising a comment function configured to allow the user to add at least one of an alphanumeric comment and an attached document to each of the plurality of knowledge articles, wherein the comment function is stored within the memory and executable by the one or more processors.

6. The system of claim 1, wherein the knowledge article module is implemented as a document file system and each of the plurality of knowledge articles is a separate document.

7. The system of claim 1, wherein the knowledge article module is implemented as a database and each of the plurality of knowledge articles is a database field.

8. The system of claim 1, wherein the service design package module is implemented as a service design database having a plurality of fields, the plurality of design attributes stored in the plurality of database fields and exactly one design attribute stored in exactly one database field.

9. The system of claim 1, further comprising a network and a computing device, wherein the system is configured such that a user accesses the server via the computing device through the network.

10. Software for service management, comprising computer readable instructions embedded on media and operable when executed to allow a user to:
(a) search a plurality of knowledge articles for an existing knowledge article addressing an issue with a service;
(b) if the existing knowledge article is not located, create a new knowledge article and populate it with a description of the issue;
(i) link the new knowledge article to at least one design attribute of the service;
(ii) link the new knowledge article to a ticket template;
(iii) designate the new knowledge article as addressing the service request;
(iv) generate a service ticket comprising at least one task with a usage function within the new knowledge article; and
(v) manage the at least one task to completion;
(c) if the existing knowledge article is located;
(i) link the existing knowledge article to at least one design attribute of the service;
(ii) update the existing knowledge article with a description of the issue;
(iii) designate the existing knowledge article as addressing the service request;
(iv) generate a service ticket request comprising at least one task with a usage function from within the existing knowledge article; and
(v) manage the at least one task to completion,
wherein each of the plurality of knowledge articles is a compilation of readable text comprising a description of the issue with the service; and
wherein the at least one task is directed to resolving the issue.

11. The software of claim 10, wherein step (a) further comprises the steps of:
(i) defining a search string of alphanumeric characters;
(ii) inputting the search string into a search function, the search function configured to search the plurality of knowledge articles for the search string and to output any of the plurality of knowledge articles containing the search string; and
(iii) reviewing the results of the search function and determining if any of the knowledge articles output by the search function address the issue,
wherein the string of alphanumeric characters is selected such that it describes the issue.

12. The software of claim 10, wherein one of steps (b)(4) and (c)(4) is automatically performed upon invoking the usage function from within the one of the existing knowledge article and the new knowledge article, wherein the service ticket is dependent upon the issue described in the one of the existing knowledge article and the new knowledge article.

13. The software of claim 12, wherein the service ticket is further dependent upon the at least one design attribute linked within the one of the existing knowledge article and the new knowledge article.

14. The software of claim 10, wherein said software is further configured to display at least one knowledge article metric.

15. The software of claim 14, wherein a knowledge article metric is selected from at least one of: the number of times one of the plurality of knowledge articles has been designated as addressing an issue, the number of times one of the plurality of knowledge articles has been edited, and the age of one of the plurality of knowledge articles.

16. The software of claim 14, further operable when executed to allow the user to:
(d) review the at least one knowledge article metric displayed;
(e) update one of the existing knowledge article and the new knowledge article with the current understanding of the issue described therein; and
(f) update at least one of a plurality of pre-defined service tickets, wherein each of the plurality of pre-defined service tickets contains at least one task configured to resolve an issue described in one of the plurality of knowledge articles.

17. A method for service management, comprising:
(a) receiving a service request for an issue with a service having a plurality of design attributes;
(b) searching a plurality of knowledge articles for an existing knowledge article addressing the issue;
(c) if the existing knowledge article is not located, creating a new knowledge article within the plurality of knowledge articles and populating it with a description of the issue;
(i) linking the new knowledge article to at least one design attribute of the service;
(ii) linking the new knowledge article to a ticket template;
(iii) designating the new knowledge article as addressing the service request;
(iv) generating a service ticket comprising at least one task with a usage function within the new knowledge article; and
(v) managing the at least one task to completion,
(d) if the existing knowledge article is located;
(i) linking the existing knowledge article to at least one design attribute of the service;
(ii) updating the existing knowledge article with a description of the issue;
(iii) designating the existing knowledge article as addressing the service request;
(iv) generating a service ticket request comprising at least one task with a usage function from within the existing knowledge article; and
(v) managing the at least one task to completion,
wherein each of the plurality of knowledge articles is a compilation of readable text comprising a description of the issue with the service; and
wherein the at least one task is directed to resolving the issue.

18. The method of claim 17, wherein step (b) further comprises the steps of:
(i) defining a search string of alphanumeric characters;
(ii) inputting the search string into a search function, the search function configured to search the plurality of knowledge articles for the search string and to output any of the plurality of knowledge articles containing the search string; and
(iii) reviewing the results of the search function and determining if any of the knowledge articles output by the search function address the issue,
wherein the string of alphanumeric characters is selected such that it describes the issue.

19. The method of claim 17, wherein one of steps (c)(iv) and (d)(iv) is automatically performed upon invoking the usage function from within the one of the existing knowledge article and the new knowledge article, wherein the service ticket is dependent upon the issue described in the one of the existing knowledge article and the new knowledge article.

20. The method of claim 19, wherein the service ticket is further dependent upon the at least one design attribute linked within the one of the existing knowledge article and the new knowledge article.

21. The method of claim 17, further comprising the step of displaying at least one knowledge article metric.

22. The method of claim 21, wherein a knowledge article metric is selected from at least one of: the number of times one of the plurality knowledge articles has been designated as addressing an issue, the number of times one of the plurality of knowledge articles has been edited; and the age of one of the plurality of knowledge articles.

23. The method of claim 21, further comprising the steps of:
(e) reviewing the at least one knowledge article metric displayed;
(f) updating one of the plurality of knowledge articles with the current understanding of the issue described therein; and
(g) updating at least one of a plurality of pre-defined service tickets, wherein each of said plurality of pre-defined service tickets contains at least one task configured to resolve an issue described in one of the plurality of knowledge articles.
